(19) United States
(12) Patent Application Publication
(10) Pub. No.: US 2003/0013483 A1
(43) Pub. Date: Jan. 16, 2003

(54) User interface for handheld communication device

(76) Inventors: Michiel R. Ausems, Palo Alto, CA (US); Matthew M. Quarneri, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/900,316

(22) Filed: Jul. 6, 2001

(51) Int. Cl. H04M 1/00

(52) U.S. Cl. 455/556; 455/566

(57) ABSTRACT

A user interface includes a main screen segregated into various screen areas. At least one of the screen areas is devoted to a system application for displaying status icons, and another of the screen areas is devoted to an interface page which may or may not link to other interface pages which are used for displaying current or recent application information for respective user applications, which user applications may be accessed through interaction with the interface page. The application information may be application status information, recent communication messages (such as e-mail messages, SMS messages, or instant messaging messages) and/or one or more upcoming events or to do items for a user. The user interaction may occur through selection with a pointing device such as a stylus, a fingertip stylus, a finger, or one or more buttons, or even through voice commands. The user interface may also include an area reserved for displaying advertisements.

### FIELD OF THE INVENTION

The present invention relates to the field of communication devices that include the functionality of personal digital assistants; more particularly, the present invention relates to a human-machine interface for operating a personal digital assistant having expanded capabilities including wireless communication capabilities.

### BACKGROUND

The popularity and use of personal digital assistants (PDAs) and wireless telephones has increased in recent years. A PDA or hand-held computer is primarily a lightweight, compact productivity and communications tool that can typically be held in one hand, leaving the other free to input data with a pen type stylus or a reduced size keyboard. In some cases, virtual keyboards (i.e., keyboard representations displayed on a touch screen display unit) may be used for data entry. A PDA provides computing and information storage and retrieval capabilities for personal or business use. Typical uses include schedule and address book storage and retrieval, as well as note taking functions. In addition, many PDAs are capable of running a variety of application software packages (e.g., currency converters, calculators, text and/or image editors, etc.).

Wireless telephones are integrated radio transmitter-receivers that are capable of accessing a vast web of existing telephone connections. Increasingly, wireless telephones are being combined with PDAs in order to perform more advanced functions, such as transmitting, receiving and displaying text messages. However, typical PDA/wireless telephone combinations include a small display area which makes it very difficult to use such units for anything other than displaying telephone numbers and, possibly, the status of a call. Where some PDA/wireless telephone combination units have utilized larger screens, the user interfaces associated with these units still has not been well provided for. That is, there has been poor integration of the different functionalities of the device and/or the user has been left to choose between using the device as a PDA or as a wireless telephone, each with its own separate user interfaces.

A user interface may be thought of as the junction or meeting point between a user and a computer program. In general, an interface is a set of commands or menus through which a user communicates with an application program and/or a device. A command-driven interface is one in which a user enters commands directly to control program/device actions. A menu-driven interface is one in which a user selects command choices from various menus (often with easy to understand shorthand names or labels for more complex commands) displayed on a screen. Graphical user interfaces (GUIs) that utilize windows, icons and various menus have become standard equipment on personal computers and PDAs, and are starting to appear on some wireless telephones.

GUIs take advantage of a computer system's graphics capabilities to make a program or device easier to use. Well designed GUIs can free a user from having to learn complex command or even menu option sequences for performing tasks. Many GUIs utilize one or more of the following attributes:

a. Pointers. These are symbols that appear on a display screen and that a user can manipulate to select objects and commands. Points may appear in various forms (sometimes depending upon the application context), such as small arrows, I-beams (often found in text processing applications), and other forms.

b. Pointing device. This is a device that allows the user to manipulate the position and operation of the pointer. Common examples are mice, trackballs and joysticks, but pen type pointing devices are commonly used with hand held computer systems.

c. Icons. These are small pictures that represent commands, files or windows. By moving a pointer onto an icon with a pointing device and then manipulating the pointing device (e.g., by clicking the mouse or tapping the screen with the pen), a user can execute the command associated with the icon (e.g., launching an application program, opening a window, etc.). Icons can often be moved around a virtual desktop as if they were real objects, to simulate and allow a user to customize a work environment.

d. Desktop. This is usually regarded as the area on a display screen where icons are grouped.

e. Windows. These are used to divide a display screen into different areas. Within a window, a user can run an application program or display a file. Windows can often be moved and sized under user control to allow for customization of the work area. Although icons can be grouped within windows, windows differ from the desktop in that ordinarily applications do not run within/on the desktop. Windows can be cascaded or tiled to bring currently executing or operating programs to the foreground for interaction with a user.

f. Menus. Most GUIs allow a user to execute commands by selecting choices from a menu. As the name implies, these are virtual representations of lists of possible commands or options that can be selected by a user. Selection from a menu is often made by highlighting the desired option with a movable cursor and then selecting the highlighted option (e.g., by clicking the mouse button or tapping the screen with a pen device). In some cases, the highlighting/selection operation can be performed simultaneously by using a special selection action, such as a double click of a mouse or a double tap of a pen.

Menus come in several forms, such as pop-up menus (which appear temporarily when a user manipulates the pointer device and usually disappear after the user makes a selection or moves the pointer/cursor), cascading menus (in which submenus open in response to a menu selection), pull-down menus (which are generally special types of pop-up menus that appear directly beneath a selected command), moving-bar menus (in which options are highlighted by a bar that moves from one item to another under user control), menu bars (which are usually arranged horizontally across a screen and may have associated pull-down menus for the various command group options included therein), and tear-off menus (which are pop-up menus that can be moved around the screen like a window).

Because the user interfaces associated with current PDA/wireless telephone devices have to date not been satisfactory, it would be desirable to have an improved user interface for such devices.

### SUMMARY OF THE INVENTION

In one embodiment, a handheld communication device has an associated a user interface that includes a main screen segregated into a number of screen areas. At least one of the screen areas is devoted to a system application for displaying system status icons for the handheld communication device, and another of the screen areas is devoted to a browser for displaying current or recent application information for respective user applications, which user applications may be accessed through interaction with the browser. The application information may be application status information, recent communication messages (such as e-mail messages, SMS messages, or instant messaging messages) to or from the handheld communication device and/or one or more upcoming events or to do items for a user of the handheld communication device. The user interaction may occur through selection with a pointing device such as a stylus, a fingertip stylus, a finger, or one or more buttons, or even through voice commands. The browser may also include an area reserved for displaying advertisements.

The status icons may be one or more of: a logo icon, a program group icon, an application name icon, a battery life indicator icon, a current time indicator icon, a received signal strength indicator icon, a help icon, a voice mail indicator icon, an input toggle icon, a backpack software icon, or a Bluetooth icon. The user applications may be one or more of: communication applications, personal information management applications, personal productivity applications, multimedia applications, or game applications. Such communication applications may include one or more of: a telephone dialer, an e-mail application, a short messaging service application, an Internet browser, a wireless access protocol browser, an instant messenger application, or a Bluetooth communication application. The personal productivity applications may include one or more of: a text editor, a spreadsheet, a database, an e-book reader, an image viewer, an image editor, or an audio manager.

Different categories of user interactions with the browser or interface page may initiate different application responses. These different categories of user interactions may include: a single selection operation, a select and hold operation and a double selection operation.

In one embodiment, the current or recent application information is navigable in a circular fashion within the recent application list within the main menu. The system application executes, in one embodiment, as a system bar in an area_located at the top of a display area of the handheld communication device. The browser then executes the primary interface in an area below the_system application area. The primary interface may consist of multiple linked pages and—include an area at the bottom of its associated pages for displaying advertisements or other information and this area may be configured to display one or more of streaming media, flash animations, banner ads, packet video, gif animations and/or other multimedia content.

Preferably, the area for the system application includes an area reserved for display of a logo icon. Selection of the logo icon causes a folder menu to be displayed on a display of the handheld communication device which lists the application groups present on the device. The folder menu includes an area reserved for a listing of recently used ones of the user applications, which may be displayed as icons within the reserved area. The folder menu may be arranged as a dropdown menu of available application groups for the handheld communication device.

Such application groups may include, but are not limited to, one or more of the following: an all application group, a communication application group, a multimedia application group, a personal productivity application group, a main application group that includes a personal information manager application, a games application group, a system application group, and a user personal applications group. Selection of one of the application groups causes a window that includes images representing those of the user applications that belong to the selected application group to be opened and displayed.

### BRIEF DESCRIPTION OF THE DRAWINGS

The present invention is illustrated by way of example, and not limitation, in the figures of the accompanying drawings in which:

FIG. 1 illustrates one example of a handheld communication device configured with a user interface that is an embodiment of the present invention;

FIG. 2 illustrates a block diagram representation of the various functional units that make up the handheld communication device shown in FIG. 1;

FIG. 3 illustrates an example of a main screen of a user interface configured in accordance with an embodiment of the present invention;

FIG. 4 illustrates an example of cursor movement within a main screen of a user interface configured in accordance with an embodiment of the present invention;

FIG. 5 illustrates an example of navigation within a main screen of a user interface configured in accordance with an embodiment of the present invention;

FIG. 6 illustrates an example of a folder menu of a user interface configured in accordance with an embodiment of the present invention;

FIG. 7 illustrates an example of an application group window of a user interface configured in accordance with an embodiment of the present invention; and

FIG. 8 illustrates an example of cursor selection of an application icon in the folder menu of a user interface configured in accordance with an embodiment of the present invention.

### DETAILED DESCRIPTION

Described herein is a user interface for a handheld communication device that includes both PDA and wireless telephone functionality. However, this is only one example of the use of the present user interface and other examples include use with PDAs alone or with wireless telephones alone. In some cases, the present user interface may also be used with personal computers and the like, or even automobiles that include built-in displays for controlling automobile, telephone or computer operations. Accordingly, the examples of use of the user interface presented below should be regarded as illustrative only and should in no way be seen as limiting the broader scope of the present invention.

Some portions of the detailed description that follows are presented in terms of algorithms and/or symbolic representations of operations on data within a computer memory (e.g., through the use of flow charts and/or descriptive text). These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing, “calculating”, “determining”, “displaying” or the like, refer to the actions and processes of a computer system, or similar electronic device, that manipulates and transforms data represented as physical (electronic) quantities within the computer system's registers and memories into other data similarly represented as physical quantities within the computer system's memories or registers or other such information storage, transmission or display devices.

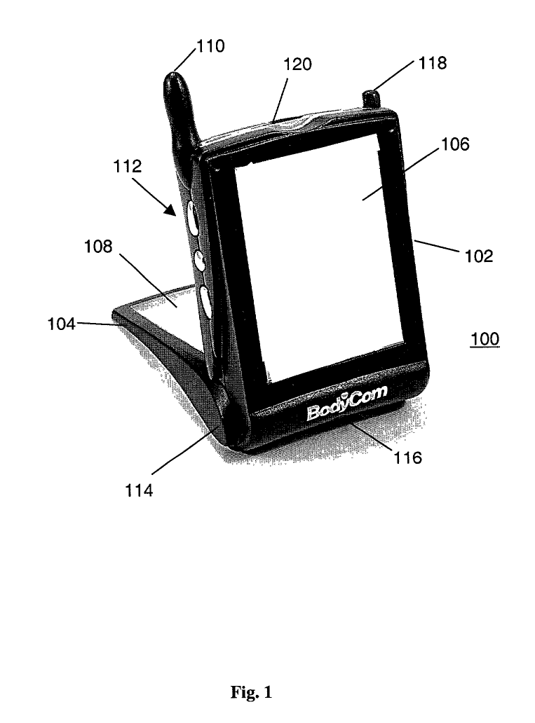

FIG. 1 illustrates a PDA telephone 100 that provides the combined functionality of a PDA and a wireless telephone and may include other features as discussed below. PDA telephone 100 may be configured to store notes, track calendar appointments, store addresses, and perform other conventional PDA applications. Furthermore PDA telephone 100 may be used to initiate and receive telephone calls, track received calls, store received alphanumeric and text messages, and carry out other functions of a wireless telephone. In addition to combining such functionality into a single unit, PDA telephone 100 may be equipped with optional enhanced feature sets, including: precise positioning capabilities, smart card reader/writer capabilities, short-range wireless transceiver operations, biometric sensor security features, speaker phone functionality, video conferencing/video capture capabilities, and/or remote control capabilities.

PDA telephone 100 includes a housing 102 and display cover 104. When closed, display cover 104 protects PDA telephone 100 from undesired contact that could damage the underlying display. According to one embodiment, display cover 104 may remain closed while a user utilizes the telephone features of PDA telephone 100. For example, while a user is conducting a telephone call, display cover 104 may remain closed so that the user does not accidentally touch or scratch the display 106 while holding the unit against an ear. Additionally display cover 104 may include a transparent window 108 in order to read information on the underlying display 106 without having to open the cover.

PDA telephone 100 also includes antenna 110, side-action buttons 112, hinges 114, and microphone 116. A speaker (not shown) and an additional microphone (not shown) may be included on the back side of housing 102 (i.e., the side opposite display 106) to permit telephone operations. Antenna 110 functions as a conductive radiation element for PDA telephone 100 that radiates and/or receives electromagnetic waves. Side-action buttons 112 allow single handed operation of PDA telephone 100 with a user's thumb and fingers. Side-action buttons 112 may be arranged on housing 102 in convenient positions so as to provide left or right-handed user access to PDA telephone 100. In addition, side-action buttons 112 may be used to execute other functions of PDA telephone, such as the muting of telephone calls, the accessing of menu items, etc. and as discussed below.

Hinges 114 permit display cover 104 to rotate about housing 102. According to one embodiment, hinges 114 may allow display cover 104 to rotate approximately 270° about a through axis near the bottom of housing 102. Hinges 114 thus permit display cover 104 to rotate to a position that enables housing 102 to rest against display cover 114. Thus, display cover 104 may function as a stand for housing 102 as shown in the illustration.

Microphone 116 transmits voice information from a user to PDA telephone 100 and converts the information to electrical signals in the conventional fashion, and may further permit the integration of voice/speech activated functions.

Display 106 provides a visual means for displaying information to a user. According to one embodiment, display 106 is approximately 60×80 mm and is configured to accommodate up to 40 characters on each of 40 lines. Further, display 106 provides for scaleable font sizes. However, one of ordinary skill in the art will appreciate that PDA telephone 100 may be configured with other types of displays of different dimensions.

PDA telephone 100 further includes a stylus 118 (shown in a recessed opening in housing 102 in the illustration). A user may control cursors and/or other elements displayed on display 106 by manipulating side-action buttons 112, or where display 106 is a touch screen, by touching fields of display 106 with a finger or with stylus 118. Stylus 118 may be a conventional pen-type stylus or fingertip stylus if so preferred. Where a touch screen is used, PDA telephone 100 may be configured to recognize handwriting written on display 106.

PDA telephone 100 may also include a smart-card slot 120 that provides access to a smart-card reader/writer (not shown in this illustration). According to one embodiment, the smart-card reader/writer may be configured to read encoded information stored on a smart card and/or to write information thereto. Smart cards often contain an embedded processing device that may store information for credit, cash, prepaid phone and/or medical smart card applications, to name a few.

Because housing 102 is adapted to allow for a speaker and microphone located on the reverse side of the unit, the length of PDA telephone 100 is now primarily determined by the length of display 106 (e.g., approximately 80 mm). Further, because of the location of such a speaker and microphone, a user is assured of not damaging display 106 when using the telephone features of PDA telephone 100. That is, the display side of the unit may be held away from a user's face when using the device as a wireless telephone.

The speaker may also operate in a loudspeaker mode so as to permit speakerphone operation of PDA telephone 100. As discussed above, display cover 104 rotates to function as a stand for housing 102. Thus, housing 102 will be angled (e.g., with reference to a level plane), whenever it is in a resting position against display cover 104. The angled position of housing 102 provides optimal positioning for the speakerphone mode since it directs microphone 116 towards a user. In the speakerphone mode, users may carry out hands-free telephone conversations without the use of additional attachments to PDA telephone 100. For video conferencing, video information may be displayed on display 106 while audio information is played out through the speaker.

In addition to the above, PDA telephone 100 may be configured with further enhancements. For example, PDA telephone 100 may include a Global Positioning System (GPS) receiver/engine having an associated antenna (not shown) for receiving signals from GPS satellites. The use of such GPS technology may allow for the inclusion of mapping and other features associated with conventional GPS devices. In addition, a small video camera (not shown) may be included for videoconference operations. In other embodiments, these and other units may be separately attached to PDA telephone 100 through peripheral ports (not shown), or backpacks (not shown), which may be mounted to the back side of housing 102. Such backpacks may accommodate a number of peripherals (such as biometric sensors, GPS receivers, video cameras, and other units) and may provide for electrical communication with other elements of PDA telephone 100 (e.g., a processing unit) through a bus arrangement (e.g., a universal serial bus, IEEE 1394 bus, or other conventional bus).

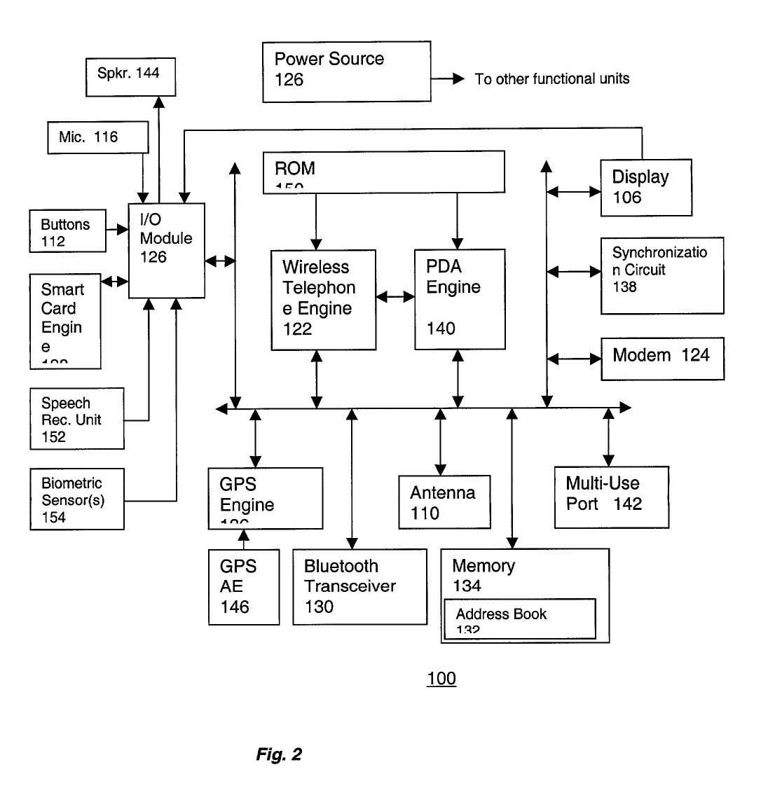

FIG. 2 illustrates the major components of PDA telephone 100 in block diagram form. PDA telephone 100 includes a wireless phone engine 122, modem 124, power source (e.g., one or more batteries or external power) 126, display unit 106, input/output (I/O) module 126, smart-card engine 128, short-range transceiver (e.g., Bluetooth transceiver) 130, address book 132 (e.g., stored in memory 134), optional GPS engine 136, synchronization circuitry (e.g., for communicating with a personal computer or other PDA unit) 138, and PDA engine 140.

Note that the wireless telephone engine 122 and PDA engine 140 may be embodied as one or more general purpose processing units (e.g., a micro-controller or microprocessor and/or digital signal processing unit) that become configured to perform their respective functions though the execution of computer software/firmware. Alternatively, these units may be special purpose application specific integrated circuits (ASICs) developed for these functions, or even general purpose field programmable gate arrays (FPGAs) or complex programmable logic devices (CPLDs) that are configured to perform these functions through firmware. The precise hardware design of these units is not critical to the present invention.

Wireless telephone engine 122 provides the wireless telephone operations of PDA telephone 100. Wireless telephone engine 122 transmits and receives audio, video, text and data information via antenna 110, for example using conventional wireless telephone compression and transmission schemes (e.g., analog and/or digital wireless telephone transmission schemes such as code division multiple access (CDMA), general packet radio service (GPRS), global system for mobile communication (GSM), time division multiple access (TDMA) and/or other schemes). Wireless telephone engine 122 may include a central processing unit (e.g., such as a digital signal processing engine and/or micro-controller), a radio frequency transceiver for transmitting and receiving data, and other conventional functional units associate with similar communication devices. According to one embodiment, wireless telephone engine 122 may operate on an analog control channel. However, in a further embodiment, wireless telephone engine 122 may also operate on a digital control channel.

Modem 124 is coupled to wireless telephone engine 122 and enables PDA telephone 100 to send and receive facsimile messages, or have Internet access. Power source 126 provides an electrical power supply to the various functional units of PDA telephone 100 whenever it is powered up. According to one embodiment, power source 126 may include one or more battery cells. However, in a further embodiment, an external power supply may be coupled to PDA telephone 100 via multi-use port 142 in order to provide a power supply.

Display 106 is coupled to wireless telephone engine 122 and PDA engine 140. As discussed above, display 106 may include a touch screen that is accessed by touching display 106 with a finger or stylus. 1/0 module 126 provides an interface for inputting and outputting data to wireless telephone engine 122, smart-card engine 128 and PDA engine 140. I/O module 126 handles data transmitted to and from side-action buttons 112, multi-use port 142, speaker 144 and microphone 116, and display 106 (e.g., where a touch screen is used).

Smart-card engine 128 processes encoded information received from a smart-card and also provides the smart card writing capabilities. Short-range transceiver 130 is a low-power transceiver (e.g., a Bluetooth transceiver) coupled to smart-card engine 128 and antenna 110. Short-range transceiver 130 enables PDA telephone 100 to establish a wireless link in order to communicate with other devices. According to one embodiment, smart-card engine 128 may be configured to communicate with various point-of-sale terminals and/or other appliances via short-range transceiver 130. In such an embodiment, a user may purchase items using PDA telephone 100 and a cash card/debit card/credit card and other smart card.

Address book 132 is coupled to wireless telephone engine 122 and PDA engine 140. Address book 132 may store a user's address and calendar information that may be accessed by both wireless telephone engine 122 and PDA engine 140. A user may directly access an entry, or select from a list of entries, in address book 122 in order to retrieve a telephone number to dial. Wireless telephone engine 122 subsequently accesses address book 132 and retrieves a desired telephone or facsimile number corresponding with the selected entry. If more than one telephone or facsimile number is available for a listing the user may select which number is to be dialed by wireless telephone engine 122 or numbers may be dialed in sequence (e.g., work numbers first, then home numbers, etc.) until a connection is made. After selecting an entry wireless telephone engine 122 dials the number and establishes a wireless connection without requiring further user input.

A user may also retrieve entries from address book 132 simply to display on display 106. According to one embodiment, the user selects an icon on display 106 that initiates a listing of the entries in address book 132. Alternatively, the user may initiate a key word search for an entry. Once an entry is selected, full address information, including telephone and facsimile numbers, is transmitted from address book 132 to PDA engine 140, and thereafter to display 106. In another embodiment, wireless telephone engine 122 may retrieve an electronic mail (e-mail) address and/or a world wide web URL from address book 132 in order to initiate a transaction.

According to a further embodiment, the user may manually select an item of an entry displayed on display 106 (e.g., telephone number, e-mail address, etc.) in order to initiate a transaction. The user may select the item by tapping the location on display 106 at which the item is displayed. After selecting the item, the user may engage wireless telephone engine 122 by manipulating side-action buttons 112. The telephone number to be dialed is then transferred from PDA engine 140 and transmitted to wireless telephone engine 122. Wireless telephone engine 122 subsequently dials the number in order to carry out the transaction.

GPS engine 136 is coupled to display 106, GPS antenna 146, I/O module 126 and PDA engine 140. GPS engine 136 receives signals from GPS satellites via GPS antenna 146 and calculates the position of PDA telephone 100 in the conventional fashion. A system user may access GPS engine 136 by manipulating side-action buttons 112, by the touch screen of display 106 or through voice activation. According to one embodiment, the positioning information received is displayed on display 106, for example using stored on retrieved maps. However, in another embodiment, the positioning information (e.g., latitude and longitude, etc.) may be presented to a user in the form of audio played out over speaker 144.

Synchronization circuitry 138 is coupled to PDA engine 140 and is used to synchronize PDA telephone 100 with a computer system in order to transfer and/or backup PDA applications and data files. Thus, PDA engine 140 functions as a data storage and processing unit for PDA telephone 100. Such synchronization schemes are well known in the art and need not be further described herein.

PDA telephone 100 also includes read only memory (ROM) 150, and voice/speech recognition module 152. ROM 150 is coupled to PDA engine 140 and wireless telephone engine 122 and stores the operating system for PDA telephone 100. According to one embodiment, PDA telephone 100 uses a Microsoft Windows CE®-based operating system. However, one of ordinary skill in the art will appreciate that PDA telephone 100 may function using other operating systems (e.g., the Palm™ operating system of 3Com Corp.). According to one embodiment, the operating system may include a web browser in order to facilitate Internet access for a PDA telephone 100. Other application software, as well as the user interface software described below may also be stored in ROM 150. In one embodiment, the user interface is hypertext markup language (HTML)-based and, therefore, may be displayed using a browser. By having an HTML-based user interface, user customization is made easier.

Voice/speech recognition module 152 is coupled to PDA engine 140 and has the ability to recognize and carry out voice commands. Voice/speech recognition module 152 stores a vocabulary of words that are used to initiate commands and access data. Voice/speech recognition module 152 may also be configured to identify a speech patterns of one or more users against stored replicas thereof.

Optional biometric sensors 154, such as fingerprint ID devices, etc., may also be coupled to PDA telephone 100 through I/O module 126. Such sensors may provide security features that prevent unauthorized users from exploiting PDA telephone 100.

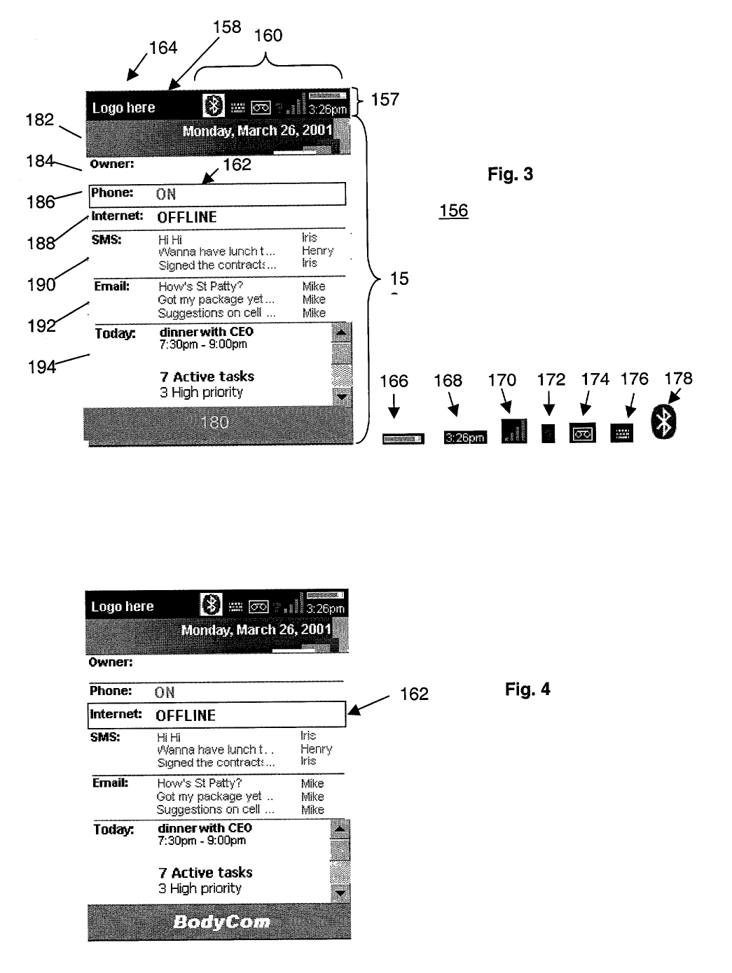

With the above understanding of the functionality of PDA telephone 100, an example of the present user interface for use with such a device may now be described. Referring to FIG. 3, a main screen 156 of such a user interface is shown. The main screen 156 may be displayed to a user via display 106 after presentation of a splash screen. Thus, when the PDA telephone 100 is booted up, a customizable splash screen may appear. This splash screen may be a user customizable image or message (e.g., in a form of either a jpeg or gif image file format), so as to allow a user to personalize his or her device. Alternatively, or in addition, the splash screen may display images or messages chosen by the handset or service provider or by an advertiser. The splash screen may be replaced after a period of time (e.g., a few seconds or so) by main screen 106, or the main screen may be displayed in response to a user input (e.g., tapping the touch screen display 106 with the stylus 118 or clicking one of the buttons 112).

In a current embodiment, PDA telephone 100 uses a Windows™-based operating system. Thus, the main screen 156 is a combination of windows in which different applications execute. Following the boot-up process, a loader application of PDA telephone 100 calls the shell (or user interface) application, which opens these windows and launches the respective application programs therein. In the illustrated embodiment, at the top of the main screen 156 a system window 157 is opened and a system application is launched to execute therein. The system application causes a system menu 158 (discussed further below) to be displayed. Below the window 157 for the system application, an application window 159 is opened and a browser (e.g., Internet Explorer™ from Microsoft Corporation of Redmond, Wash.) is launched therein. The browser loads a page (e.g., index.html) from the memory of PDA telephone 100 in the conventional fashion, which results in the display shown in the figure. That is, the page displayed in the application window 159 of the main screen 156 is a hypertext markup language (HTML) page which itself displays objects and information from other user applications of PDA telephone 100. Thus, this page acts as an interface or gateway for accessing other features and functions of the handheld communication device. In one embodiment, the page need not even be stored locally, but could be downloaded from a remote server or content storage location via wireless communication means or by synchronization with a personal computer. In other cases, the page could include instructions to download portions of content from remote locations. The techniques used to display such information within a browser and an HTML page is well known in the art and need not be further described herein.

Thus main screen 156 is organized in a cascaded fashion as a number of different screen areas (windows), some devoted to applications for displaying system information for the PDA telephone 100 and others devoted to applications for displaying current or recent application information for various user applications executing on PDA telephone 100. Thus, in a single screen, the functionalities of the device itself as well as the PDA and wireless telephone portions of the device are arranged for presentation to the user. That is, a single user interface screen allows the user to, at a glance, gain information about all functionality aspects of his or her device.

Main screen 156 may be a single page or multiple pages. The main screen 156 may also link to multiple pages which organize system functionality into subgroups organized by page. Essentially, this would allow a user to operate the PDA telephone 100 from a collection of pages.

As indicated above, the pages which are loaded do not necessarily need to be stored on the PDA telephone 100, they can be downloaded from a remote server over the Internet. This would effectively allow access to the functionality of the device to be controlled from a Web site. In one embodiment if the user has an application on the device that is marked as hidden he or she would only be able to access it if they had the proper interface page. He or she would obtain this page from an associated html server.

The system status information may be displayed through the use of various icons (as discussed below), while the application information may take the form of text describing application status and/or recent or upcoming event information (e.g., for the PDA applications such as calendars, to do lists, address books, etc.), received and/or transmitted messages and/or e-mails (e.g., for e-mail and/or short message service communications). As discussed below, the various applications themselves can be accessed through user interaction with the system application and/or interface running within the browser. Thus, users may launch and interact with applications via the main screen and screens associated with the main screen.

At the top of the main screen 156, a system application executes in system window 157 and system menu 158 is displayed. The system menu 158 is accessible at all times on PDA telephone 100. In some cases, the system menu 158 may be “hidden” by an application, but if the top area of the display 106 is tapped (e.g., with stylus 118), the system menu 158 will appear (in some cases with the main screen 156 open, as discussed below). In one embodiment, the system menu 158 will be configured to always be present on the display 106 regardless of what application is in the foreground, however, a user may be able to change this setting through the use of a menu command sequence (not shown) such as: Menu Settings>System Bar>Visibility in a menu settings applet. Such a command sequence may be implemented using a series of cascading menus as is common in the art.

In the default mode, if an application has an associated application menu, that application menu will appear directly below the system menu 158 in the display. If an application is displayed in landscape mode (as opposed to the portrait mode illustrated in the figure) the system menu 158 may be translated as well so as to preserve a uniform display appearance.

As indicated above, the system menu 158 contains a number of status icons 160 that communicate information regarding the status of PDA telephone 100 and its various operational units. When these icons160 are selected (e.g., individually using stylus 118), they provide links to settings properties, applets and/or applications. At different shell states, different icons 160 may be displayed. For example, when the user interface is displaying the main screen 156 (as shown), icons 160 may be provided for a company logo, backpack software (if a backpack is present—not shown in the illustration), user help (if selected), voicemail, sound, Bluetooth (if active), received wireless telephone system signal strength, battery life and/or time. If the user interface is, however, displaying a group viewer (discussed further below), the system menu 158 may include icons for the company logo, the group name, the received signal strength, battery life and/or time/date. Further, if the user interface is displaying a currently running application, the system menu 158 may display icons for the company logo, the application name, an input toggle, battery life and/or time. Of course, other icon configurations can be used for these or other shell states and the above examples are merely meant to indicate possible options that may be adopted. In one embodiment, the user may select which icons to display for a given shell state.

The following Table 1 describes specific system menu 158 features. In addition to a description of the various icons, the functionality associated with each is presented. Selection of an icon may be performed by using the buttons 112 or by using stylus 118 (or other pointing device). In other cases, voice commands may be used for navigation if an appropriate voice recognition software or hardware module is used with PDA telephone 100.

For button selection, the screen cursor 162 (which may appear as a box around a screen area and/or as a highlighted region within display 106) is moved to the system menu 158 screen area at the top of the display (e.g., using the up/down ones of buttons 112) and the screen area selected (e.g., using the center one of buttons 112). Then, individual icons may be selected by scrolling through the icons (again using the up/down ones of buttons 112) and making a selection using the center button. For stylus selection, one need simply tap the display 106 at the location of the icon, in the conventional fashion. Note that in some cases, a button click and hold (or stylus double tap) may activate different functionality (or initiate a different response) than a single click and release (or single stylus tap). For clarity, the individual icons are shown to the right of the main screen image.

TABLE 1
System Menu Features

| Feature/ | |
|---|---|
| Item | Description |
| Logo | As indicated above, a company logo may be set to be present |
| Icon | when the main screen 156 is opened (and possibly when an |
| 164 | application is running). In essence, this logo is a small graphic |
| | image that is displayed in a corner of display 106, within system |
| | menu 158. In other embodiments, a user-selected image may be |
| | set to appear in this location, in order to provide personalization |
| | of the PDA telephone 100. |
| | When a program group is open, the system menu 158 may be |
| | configured to change so that the name of that group appears |
| | beside or n place of the logo or other image. Similarly, when an |
| | application is running in the foreground, the name of the |
| | application may appear beside or in place of the logo or other |
| | image. |
| | The logo or other image/name is also an icon, which means it |
| | has some associated functionality. In one embodiment, one tap |
| | or click of the logo icon 1164 displays the main page 156. Thus, |
| | if the system menu is displayed at the top of a currently running |
| | application, the user may bring up the main page 156 by simply |
| | selecting the logo icon 164 in this fashion. Alternatively, this |
| | action may cause a folder menu to be displayed. |
| | A tap/click and hold user input may have different functionality, |
| | for example, this type of selection operation may turn off the |
| | display 106, but leave the device in an operational state. The |
| | display 106 may be reactivated in response to any other user |
| | input, such as a screen tap or a button click. |
| | In some embodiments, when the main screen 156 is open and the |
| | user clicks or taps on the logo icon 164 for a second time in |
| | succession (essentially a double-tap/click selection operation), |
| | the PDA telephone 100 may be configured to display the last |
| | place in the shell that the user was at before the main screen 156 |
| | was open. For example, a user running an application in the |
| | communications folder (see below) may have opened the e-mail |
| | and telephone applications. On a first tap or selection operation |
| | of the logo icon 164, the main screen 156 is displayed. The user |
| | can then return to the communications folder by tapping a |
| | second time on the logo icon 164. In addition, a double tap/click |
| | on the logo icon 164 from the main screen 156 may cause the |
| | contents of the next folder in the folder menu (see below) to be |
| | displayed. |
| Battery | This is an icon that provides a visual indication of a battery and |
| Life | provides the user with a means for receiving information about |
| Indica- | the current battery life. Of course, PDA telephone 100 will need |
| tor Icon | to be equipped with conventional means for determining such |
| 166 | information (such as a voltage/current monitoring circuit that can |
| | be used to obtain information regarding the current battery life |
| | remaining in the unit's battery power source). Such circuitry is |
| | well known in the art and the precise configuration of such a |
| | circuit is not critical to the present invention. A single tap or |
| | click of this icon 166 may display a pop-up menu or window |
| | that includes a description of the remaining battery life, for |
| | example: “Battery Life @ X %” where X is a value between, |
| | say 10 and 100 in increments of 5. |
| | A tap/click and hold selection operation may have a different |
| | result. In one embodiment, this type of operation will cause a |
| | system power applet to be launched. This may be an applet that |
| | allows the user to vary power operating conditions of the PDA |
| | telephone 100. Of course, other operations may be launched by |
| | such a selection input and the precise application is not critical to |
| | the present invention. |
| Current | This is an active icon that displays the current time (user set- |
| Time | table) in the conventional fashion. A single tap or other selection |
| Indica- | operation may bring up a pop-up window with the current date. |
| tor Icon | Other selection operations, e.g., a tap and hold, may be used to |
| 168 | launch a time setting applet or the time in another time zone or |
| | zones. |
| Signal | This icon may change dynamically to indicate received signal |
| Strength | strength, with a roaming sign if applicable, as is commonly |
| Indica- | found on conventional wireless telephones. For example, the |
| tor Icon | number of illuminated signal strength bars may indicate a |
| 170 | stronger or weaker received signal. The signal strength indicator |
| | icon 170 may also provide a means for launching a phone dialer |
| | or other telephone related application. Thus, one type of selec- |
| | tion operation (e.g., a single tap) may bring up the application, |
| | while another type of selection operation (e.g., a tap and hold) |
| | may bring up a different application (e.g., such as an applet that |
| | allows the user to change the current telephone settings). When |
| | the telephone functionality of the unit is not activated, the signal |
| | strength icon 170 may change to display a red “cross-out” |
| | symbol. |
| Help | Resembling a question mark (or other easily identifiable sym- |
| Icon | bol), the help icon may be used to launch a help application. In |
| 172 | response to a selection operation (e.g., a single tap/click) help |
| | files pertaining to the application or file currently displayed in |
| | the foreground may be launched. In some cases, these help files |
| | will be HTML files that can be displayed in the browser. |
| Voice | As with other wireless telephones, the PDA telephone 100 may |
| Mail | be configured for on-board voicemail storage and retrieval or, in |
| Indica- | some cases, this may be a feature provided by the network ser- |
| tor Icon | vice provider. The voicemail indicator icon 174 may appear |
| 174 | whenever there is unplayed voice mail waiting for the user. |
| | In one embodiment, one tap/click on the icon accesses the user's |
| | voicemail (e.g., by initiating local playback if the messages are |
| | stored locally or by dialing a user-defined telephone number at |
| | which such messages may be retrieved), and prompts the user |
| | for a password, or automatically enters a saved, user-defined |
| | password if such a password is needed to access the stored |
| | messages. Other selection operations, such as a tap and hold, |
| | may launch an applet that allows the user to define his/her voice- |
| | mail preferences (e.g., a telephone number to call to retrieve |
| | messages, password settings (prompt or automatic), etc.). |
| Input | As indicated above, PDA telephone 100 may be configured to |
| Toggle | respond to different types of user input, such as via a keyboard |
| Icon | (real or virtual) or through handwriting recognition (e.g., as is |
| 176 | commonly used with handheld computer systems). The input |
| | toggle icon 176 may be used to indicate the currently set user |
| | input mode. Thus, the icon may toggle between having the |
| | appearance of keyboard and another input instrument (e.g., a pen |
| | or stylus) according to the current input mode. A user may select |
| | the input method by performing a selection operation (e.g., one |
| | tap/click) on the icon to display an Input Method field. Such a |
| | field may provide details regarding the current input mode. |
| | Other selection operations, for example a tap/click and hold, |
| | may toggle between input modes: keyboard or character recog- |
| | nizer (where one, say the keyboard, is the default input method). |
| | When character recognition software is used, the icon may |
| | change from a keyboard to a pen. |
| Back- | If present, selection of the backpack icon triggers the shell to |
| pack | load a status icon that links the primary application associated |
| Soft- | with the backpack. A single tap/click opens the primary back- |
| ware | pack software. Different backpack options may include a digital |
| Icon | camera package, a GPS receiver/mapping package, a biometric |
| (not | sensor package, and others. Where no backpack is used with |
| shown | PDA telephone 100, no icon is shown in the system menu 158. |
| but may | |
| resem- | |
| ble a | |
| back- | |
| pack or | |
| similar | |
| article) | |
| Blue- | The Bluetooth icon 178 provides a visual indication of the status |
| tooth | of the short-range transceiver 130. If the icon is not visible |
| icon | Bluetooth coverage is not available. If the icon is visible, |
| 178 | Bluetooth service is available and a single tap (or other selection |
| | operation) on the icon may display a pop-up description that |
| | reads: “Bluetooth is Active”. |
| | A tap and hold (or other selection operation) may launch a |
| | Bluetooth Properties page (or other application), which lists |
| | partnerships, and could include a Bluetooth On/Off mode control |
| | as well as other controls and properties related to this service. |

As described above, the main screen 156 is also the screen from which a user is able to quickly access various applications of the PDA telephone 100. For example, various communication applications (such as a phone application, internet application, short messaging service (SMS) application and e-mail application) may all be accessed from the main screen 156. The browser executing in application window 159 displays an html page that includes commands that cause the browser to query user applications for the information to be displayed. These queries may be relayed through a controller in the conventional fashion. For example, the html page may include a command that causes the browser to query the phone application to determine if the phone application is currently running or not. If it is running, the “ON” message will be displayed in the area of the browser which the html page has reserved for such information. Further, when a screen area of the browser or an icon displayed by the browser is selected (e.g., tapped with a stylus), the controller launches the application associated with the screen area or icon in the conventional fashion. This is similar to a user selecting an object displayed in a browser of a personal computer using a mouse and having the corresponding action associated with the object initiated (e.g., beginning playback of a movie, completing an e-transaction or jumping to another web page using a hyperlink).

Since the page displayed by the browser in the application window 159 is written in HTML (though in other embodiments other programming languages, such as the extensible markup language, XML, could be used), its look and feel or entire design should be easily customizable by an operator or enterprise such that, if desired, the entire page or collection of pages which comprise the interface to the device could be redesigned. In this embodiment General ActiveX controls should enable the operator/enterprise to launch any application on the device from its interface pages. In other instantiations Javascript, Java, or other application interface languages could be used. In addition, the use of HTML as a programming language will allow for a user-definable background for the screen, which can either be a solid color or a .jpeg/.gif image, to be set. Page text may then be displayed on top of the selected background.

The interface page can be dynamically updated either by the user, or by an automatic updating application running on the device, or by remote control initiated by a secure connection to a properly privileged host.

The user should also be able to set the order in which the various applications are listed on the main screen 156. Settings for making such modifications may be accessed through a Page Settings applet (similar to a control panel for a personal computer that allows a user to customize a desktop), or by tapping/clicking and holding on the footer screen area 180.

The date and time displayed at the top of the main screen 156 should dynamically update, as is common for such indicators on conventional wireless telephones and PDAs. Date and time settings can be configured using the Page Settings applet, and the user should be able to define the display order of the day, month, and year as well as the 12-hr. versus 24-hr. time format. The following Table 2 describes the remaining main screen 156 components in detail.

TABLE 2
Main Screen Components

| Compo- | |
|---|---|
| nent | Description |
| Main | Appearing below the system menu 158, this top section of the |
| Screen | application window 159, which could be used to display the date |
| Banner | (as shown), or other information appears as a banner screen area. |
| 182 | In other embodiments, this screen area is used for one of the |
| | application information displays and the date is accessible |
| | through a selection operation of the time icon 168. |
| Con- | In one embodiment, in the default state the contacts screen area |
| tacts | 184 may be used to display the device owner's name or other |
| Area | information (e.g., the PDA telephone unit's own telephone |
| 184 | number). Taping/clicking on this area 184 brings up the contacts |
| | or address book application of the PDA. A tap/click and hold |
| | may bring up the owner's personal information (which may be |
| | stored through a registration applet or other means). |
| Phone | This screen area may, in a default state, display the telephone |
| Area | status (ON or OFF) of the PDA telephone 100 and, if so desired, |
| 186 | the service provider's network name or other information. A |
| | roaming icon may also be displayed if the user is roaming out- |
| | side of his/her home service area. When tapped, or otherwise |
| | selected, the telephone dialer application may be launched. A |
| | tap/click and hold may display a telephone settings applet. |
| Internet | This screen area may, in a default state, display the Internet |
| Area | status (online or offline) of the PDA telephone 100. By tapping |
| 186 | (or otherwise selecting) this screen area, the user may launch an |
| | Internet browser application, which operates in the conventional |
| | fashion. Tap/click and hold may display a list of favorite web- |
| | sites or other information (such as an Internet connection prefer- |
| | ence menu or list of recently visited web sites, etc.). |
| SMS | This screen area may be used to displays a list (e.g., three) of |
| Area | recently received and/or transmitted instant messages using an |
| 188 | SMS application. When this area is tapped or otherwise selected, |
| | an Inbox or other message receipt applet of the SMS application |
| | may be displayed to allow the user to read newly received |
| | messages. Tap/click and hold may launch the application and |
| | allow a user to input text for a new message. Any unread |
| | messages may be shown in BOLD font type for easy |
| | identification. |
| Instant | This screen area may be used to display the status of an instant |
| Messag- | messaging application: Online, Busy, Away from My Desk, Out |
| ing | to Lunch, On the Phone, etc. A tap/click in this area may launch |
| Area | the application to allow a user to read/respond to a message or to |
| (not | create a new message. The main screen 156 can only accommo- |
| shown) | date so many applications at one time before readability is |
| | diminished to a point that a user may find unacceptable. There- |
| | fore, a user may choose which application s/he wants to display |
| | in the main screen 156. In the present illustration, the user has |
| | decided not to display an instant messaging screen area, but |
| | additional or different screen areas may be added or deleted at |
| | will. Also, if a PDA telephone 100 is not configured with a |
| | particular application, the present user interface will not reserve |
| | main screen area for a “missing” application. That way, |
| | the entire display area may be used to display information for |
| | applications that are present. |
| E-mail | This screen area may be used to display the most recent (e.g., |
| Area | three) transmitted and/or received e-mail messages. In another |
| 190 | embodiment, only high priority messages may be displayed or |
| | user-selected messages may be displayed. When this screen area |
| | is tapped or clicked, the Inbox of the e-mail application may be |
| | displayed to allow a user to read newly arrived or previously |
| | received e-mail messages. Tap/click and hold may launch the |
| | e-mail application and allow a user to compose and send a new |
| | message. Unread messages may be displayed in BOLD font type |
| | in the e-mail screen area 190 to allow for easy identification. |
| PIM | This screen area may be used to display upcoming appointments |
| (Person- | and/or to do items and/or a contacts (address book) list. When |
| al Infor- | the area is tapped or clicked, the PIM application may be |
| mation | launched to allow a user to interact with his/her PIM (e.g., to |
| Man- | make to do items as completed, to cancel or add new appoint- |
| age- | ments, etc. Tap/click and hold may immediately take the user to |
| ment) | a new event input screen, allowing the user to quickly update |
| Area | his/her PIM with a new item and then return to the main screen |
| 192 | 156 by tapping the logo icon 164. |
| | In one embodiment, the default information management view |
| | displays the next scheduled event. This screen area contains a |
| | scroll bar when scrolling is required. |
| Footer | This is a banner graphic section, which could contain an image, |
| Area | company information or dynamically loaded advertisements. |
| 180 | When tapped or clicked, the banner changes to a full screen view |
| | of whatever was shown in the footer area 180. If the banner was |
| | an advertisement the browser may open to a related Internet web |
| | site. A tap/click and hold may invoke different functionality, |
| | such as launching a settings menu that allows the user to modify |
| | the settings of the main screen 156 (e.g., the order of the screen |
| | areas, including which are displayed and which are not, and/or |
| | their contents). |

As discussed above, different navigation and selection options exist for the present user interface. With a single tap of the stylus 118 on display 106 (and in a designated screen area as indicated in Table 2), a user can launch any of the applications (or others depending on the software configuration of PDA telephone 100) mentioned above. The user can also navigate using the up and down ones of buttons 112, and the center action or selection button (or even voice commands). To illustrate, consider that FIG. 3 shows that the currently selected application is the Phone application (as indicated by the position of the cursor 162). If one of the up or down ones of buttons 112 is pressed, the cursor 162 will move to the next screen area in order as shown in FIG. 4. Thus, the currently selected application will become the Internet application, as illustrated in the drawing. To launch this application, the user may click or click and hold the center one of buttons 112, as discussed in detail above.

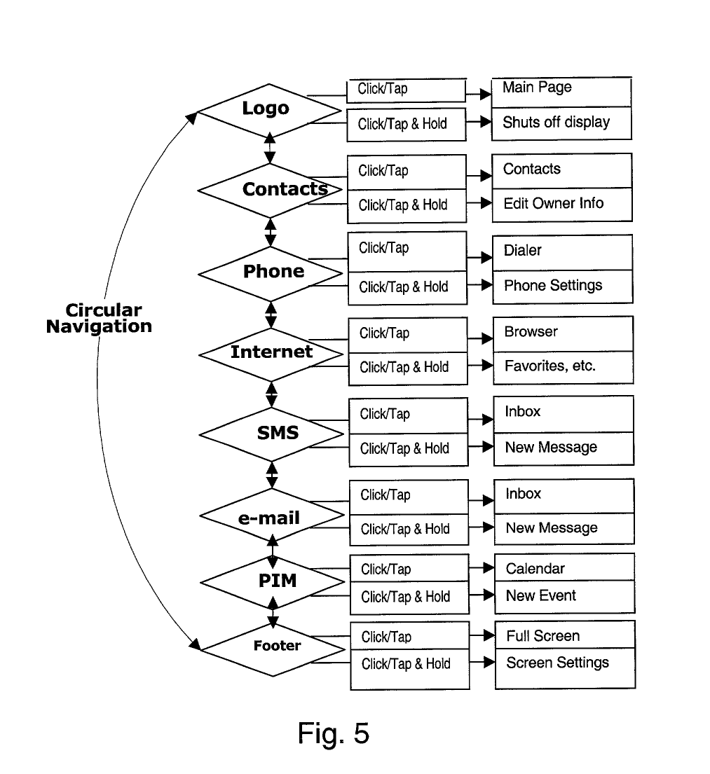

Using the up/down ones of buttons 112 then, the user can circularly navigate through the applications/screen areas of the main page 156. The middle one of buttons 112 is used to start the selected application, with single clicking and clicking and holding operations allowing for separate responses as illustrated in FIG. 5. As shown, the various selection actions are responsible for the corresponding operations as discussed in detail in Table 2.

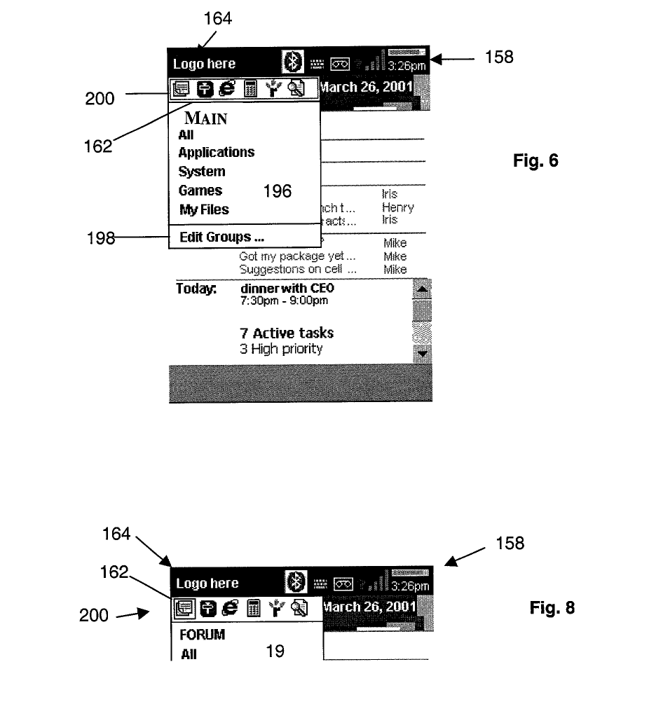

As indicated above, in one embodiment when the user selects the logo icon 164, or presses the center one of buttons 112 when the logo or group name is selected, a folder menu 196 will be displayed (e.g., as a dropdown menu) as shown in FIG. 6. From this menu, the user can add, edit, or remove an application or other group; define the content in each group; and/or arrange the sequence that appears in the drop-down menu by accessing various menu settings. These settings may be located in the system folder (i.e., control panel), or can be accessed through the last item 198 in the dropdown list, Edit Groups. Such access will cause a file or explorer type window to be displayed, and that window allows users to drag and drop applications between groups in the conventional fashion associated with Windows™-based applications.

When the folder menu 196 is displayed, it may appear directly beneath the logo icon 164. The top item in the dropdown menu list may be (as shown) an application box 200 displaying the most recently used application icons. The other items listed in the menu represent various application groups (applications in folders) on the PDA telephone 100.

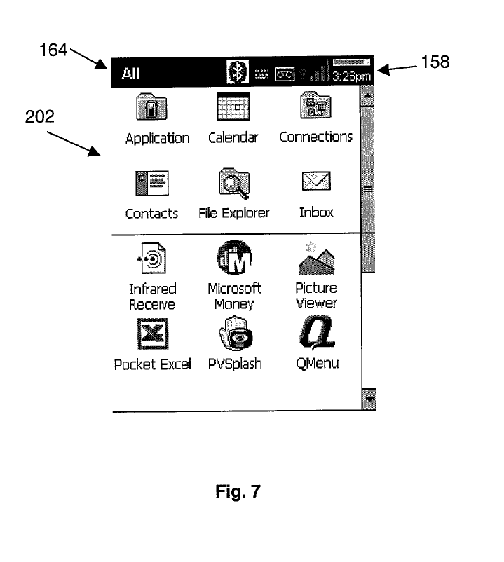

From the folder menu 196, when the user selects an application group that group is displayed in an associated window 202, as shown in FIG. 7. In this example, assume the user selected the “All” application group from menu 196. In response, the corresponding All Applications folder opened in a window 202 on display 106. These folders display images taken from icons associated with the applications that make up the group. The images can be selected and used to launch the associated application programs as is commonly done using icons. The difference here is that the image is a .jpg or .gif (or other) image file and not a true icon. When a selection operation is performed, the browser calls a controller which launches the application associated with the screen area of the browser which was selected (i.e., the screen area of the selected image file).

Anytime the user selects the logo icon 164 when the folder menu 196 is exposed the user will initiate one of two actions, depending upon the then-present shell state: If the present applications group is not displayed, then it will be displayed. If the present applications group is displayed, then the contents of the next applications group in the folder menu 196 list will be displayed.

The user can open any folder or launch any recently used application by appropriate selection operations from the folder menu 196, using the stylus 118 or buttons 112 to navigate to and start a selected application. If the user presses the center one of buttons 112 when the most recently used application box 200 is selected by the cursor (as shown in FIG. 6), the user will be allowed to further select an application by using the up/down ones of buttons 112, as illustrated in FIG. 8.

The up/down (or rocker navigation) ones of buttons 112 can be used to navigate within the most recently used application box 200 when the application box 200 has been first selected using cursor 162. Upon such selection, the cursor 162 highlights the individual application icons within application box 200 and the user can then press the up and down ones of buttons 112 to navigate right and left through the individual application icons. Selecting a highlighted icon will then launch the associated application.

The user can return the navigation flow to the folder menu level by pressing the center one of buttons 112 (also called the action button) when the most recently used application box 200 is highlighted in its entirety by cursor 162. That is, as cursor 162 scrolls through the individual application icons, at the end of the scroll the entire application box 200 may be highlighted to permit a return to normal navigation.

For ease-of-use, like applications can be accessed on the PDA telephone 100 from default menu groups arranged in folder menu 196. The following Table 3 lists some examples of default menu groups and their associated applications. Of course these groups and applications are presented by way of example only and other groups may be used and/or created by the user.

TABLE 3
Folder Menu Groups and Application Contents

| Menu | |
|---|---|
| Group | Applications |
| All | All applications on the PDA telephone 100. |
| Main | A PIM (e.g., Contacts, Calendar/Data Book/Schedule, Tasks/ |
| | To Do/Note Pad), an account manager (e.g., Microsoft |
| | Money ™), various Time applications (e.g., a world time clock), |
| | Alarm/Stopwatch, Calculator, Drawing Pad/Image Editor, and |
| | Smart Card Reader/Writer Application, etc. |
| Com- | Telephone dialer, SMS, E-mail, Instant Messenger, Facsimile |
| muni- | send/receive application, Internet Browser, Wireless Access |
| cations | Protocol Browser, Bluetooth Communication and File Transfer |
| | Agent, etc. |
| Appli- | Personal productivity applications such as a Text Editor, Spread- |
| cations | sheet, Database, Presentation Application, E-Book Reader, |
| | Image Viewer/Editor, Calculator, Audio Manager, etc. |
| Multi- | Various Media Player(s) (e.g., MIP3, AVI, ASF, MPEG, |
| media | Quicktime ™, etc.), Audio Manager, Macromedia ™ FLASH |
| | Player, and RealPlayer ™, etc. |
| Games | Minesweeper ™, Solitaire, Chess, Tetris ™, etc. |
| System | Includes various system level files and control panels, and |
| | specialized applets (e.g., anti-virus applications, etc.), etc. |
| My | File explorer access to personal folders. |
| Files | |

In addition to the above, a variety of other application or system level programs may be included, according to the desired user functionality. The exact make up of the software suite for PDA telephone 100 is not critical to the present invention.

Thus, a user interface for a handheld communication device that includes both PDA and wireless telephone functionality has been described. Although discussed with respect to certain illustrated embodiments, those of ordinary skill in the art will appreciate that various modifications may be made to the systems described herein and that such modifications would represent insubstantial differences from the broader scope of the present invention. Accordingly the invention should only be measured in terms of the claims that follow.

What is claimed is:

1. A user interface for a handheld communication device, comprising a main screen segregated into a number of screen areas, at least one of the screen areas devoted to a system window in which a system application for displaying status icons for the handheld communication device executes, and another of the screen areas devoted to an application window in which a browser executes to display an HTML page having current or recent application information for respective user applications, which user applications may be accessed through interaction with the browser.

2. The user interface of claim 1 wherein the application information comprises user application status information.

3. The user interface of claim 1 wherein the application information comprises recent communication messages to or from the handheld communication device.

4. The user interface of claim 3 wherein the communication messages comprise one or more of e-mail messages, short messaging service messages, or instant messaging service messages.

5. The user interface of claim 1 wherein the application information comprises one or more upcoming events or to do items for a user of the handheld communication device.

6. The user interface of claim 1 wherein the user interaction comprises one or more of: selection with a pointing device or selection using voice commands.

7. The user interface of claim 6 wherein the pointing device comprises one or more of: a stylus, a fingertip stylus, a finger, or one or more buttons.

8. The user interface of claim 1 wherein segregated comprises being divided into rows as in a table.

9. The user interface of claim 1 wherein the status icons comprise one or more of: a logo icon, a program group icon, an application name icon, a battery life indicator icon, a current time indicator icon, a received signal strength indicator icon, a help icon, a voice mail indicator icon, an input toggle icon, a backpack software icon, or a Bluetooth icon.

10. The user interface of claim 1 wherein the user applications comprise one or more of:
communication applications, personal information management applications, personal productivity applications, multimedia applications, or game applications.

11. The user interface of claim 10 wherein the communication applications comprise one or more of: a telephone dialer, an e-mail application, a short messaging service application, an Internet browser, a wireless access protocol browser, an instant messenger application, or a Bluetooth communication application.

12. The user interface of claim 10 wherein the personal productivity applications comprise one or more of: a text editor, a spreadsheet, a database, an e-book reader, an image viewer, an image editor, or an audio manager.

13. The user interface of claim 1 wherein the browser further executes to display advertisement information in a designated area of the application window.

14. The user interface of claim 1 wherein different categories of user interactions with the browser initiate different user application responses.

15. The user interface of claim 14 wherein the different categories of user interactions are selected from the list comprising: a single selection operation, a select and hold operation and a double selection operation.

16. The user interface of claim 1 wherein the current or recent application information is displayed in respective screen areas that are navigable in a circular fashion.

17. The user interface of claim 1 wherein the system window is located at the top of a display area of the handheld communication device.

18. The user interface of claim 17 wherein the application window is located below the system window.

19. The user interface of claim 18 wherein the HTML page includes an area reserved for displaying advertising information that is configured to display one or more of: streaming media information, flash animation information, banner ads, packet video information, gif animations, image files, or multimedia information.

20. The user interface of claim 19 wherein the area reserved for displaying advertising information is located at the bottom of the application window.

21. The user interface of claim 1 wherein the system window includes an area reserved for display of a logo icon.

22. The user interface of claim 21 wherein selection of the logo icon causes a folder menu to be displayed on a display of the handheld communication device.

23. The user interface of claim 22 wherein the folder menu includes an area reserved for a listing of recently used ones of the user applications.

24. The user interface of claim 22 wherein the recently used ones of the user applications are displayed as icons within the reserved area.

25. The user interface of claim 22 wherein the folder menu comprises a dropdown menu of available application groups for the handheld communication device.

26. The user interface of claim 25 wherein the application groups include one or more of:
an all application group, a communication application group, a multimedia application group, a personal productivity application group, a main application group that includes a personal information manager application, a games application group, a system application group, and a user personal applications group.

27. The user interface of claim 25 wherein selection of one of the application groups causes a window that includes images representing those of the user applications that belong to the selected application group to be opened.

28. A handheld communication device comprising a display unit coupled to a processor having access to a computer-readable storage medium having stored therein computer-readable instructions, which, when executed by the processor, cause the processor to display a user interface on the display of the handheld communication device, which user interface includes a main screen segregated into a number of screen areas, at least one of the screen areas being devoted to a system application for displaying status icons for the handheld communication device, and another of the screen areas being devoted to a browser application for displaying current or recent application information for respective user applications, which user applications may be accessed through user interaction with the browser.

29. The handheld communication device of claim 28 wherein the application information comprises user application status information.

30. The handheld communication device of claim 28 wherein the application information comprises recent communication messages to or from the handheld communication device.

31. The handheld communication device of claim 30 wherein the communication messages comprise one or more of e-mail messages, short messaging service messages, or instant messaging service messages.

32. The handheld communication device of claim 28 wherein the application information comprises one or more upcoming events or to do items for a user of the handheld communication device.

33. The handheld communication device of claim 28 wherein the user interaction comprises one or more of: selection with a pointing device or selection using voice commands.

34. The handheld communication device of claim 33 wherein the pointing device comprises one or more of: a stylus, a fingertip stylus, a finger, or one or more buttons.

35. The handheld communication device of claim 28 wherein segregated comprises being divided into cascaded windows.

36. The handheld communication device of claim 28 wherein the status icons comprise one or more of: a logo icon, a program group icon, an application name icon, a battery life indicator icon, a current time indicator icon, a received signal strength indicator icon, a help icon, a voice mail indicator icon, an input toggle icon, a backpack software icon, or a Bluetooth icon.

37. The handheld communication device of claim 28 wherein the user applications comprise one or more of: communication applications, personal information management applications, personal productivity applications, multimedia applications, or game applications.

38. The handheld communication device of claim 37 wherein the communication applications comprise one or more of: a telephone dialer, an e-mail application, a short messaging service application, an Internet browser, a wireless access protocol browser, an instant messenger application, or a Bluetooth communication application.

39. The handheld communication device of claim 37 wherein the personal productivity applications comprise one or more of: a text editor, a spreadsheet, a database, an e-book reader, an image viewer, an image editor, or an audio manager.

40. The handheld communication device of claim 28 wherein the browser further executes to display advertisement information in a designated area of the application window.

41. The handheld communication device of claim 28 wherein different categories of user interactions with the browser initiate different user application responses.

42. The handheld communication device of claim 41 wherein the different categories of user interactions are selected from the list comprising: a single selection operation, a select and hold operation and a double selection operation.

43. The handheld communication device of claim 28 wherein the current or recent application information is displayed in respective screen areas that are navigable in a circular fashion.

44. The handheld communication device of claim 28 wherein the system application executes in a system window located at the top of a display area of the handheld communication device.

45. The handheld communication device of claim 44 wherein the browser executes in an application window located below the system window.

46. The handheld communication device of claim 45 wherein the browser loads an HTML page that includes an area reserved for displaying advertising information that is configured to display one or more of: streaming media information, flash animation information, banner ads, packet video information, gif animations, image files, or multimedia information.

47. The handheld communication device of claim 46 wherein the area reserved for displaying advertising information is located at the bottom of the application window.

48. The handheld communication device of claim 44 wherein the system window includes an area reserved for display of a logo icon.

49. The handheld communication device of claim 48 wherein selection of the logo icon causes a folder menu to be displayed on a display of the handheld communication device.

50. The handheld communication device of claim 49 wherein the folder menu includes an area reserved for a listing of recently used ones of the user applications.

51. The handheld communication device of claim 50 wherein the recently used ones of the user applications are displayed as icons within the reserved area.

52. The handheld communication device of claim 49 wherein the folder menu comprises a dropdown menu of available application groups for the handheld communication device.

53. The handheld communication device of claim 52 wherein the application groups include one or more of: an all application group, a communication application group, a multimedia application group, a personal productivity application group, a main application group that includes a personal information manager application, a games application group, a system application group, and a user personal applications group.

54. The handheld communication device of claim 53 wherein selection of one of the application groups causes a window that includes images representing those of the user applications that belong to the selected application group to be opened.

55. A method, comprising displaying, on a single screen of a user interface of a handheld communication device, system status information for the handheld communication device in a system window and application information for a number of user applications of the handheld communication device in a browser executing in an application window.

56. The method of claim 55 wherein the application information comprises user application status information.

57. The method of claim 55 wherein the application information comprises recent communication messages to or from the handheld communication device.

58. The method of claim 57 wherein the communication messages comprise one or more of e-mail messages, short messaging service messages, or instant messaging service messages.

59. The method of claim 55 wherein the application information comprises one or more upcoming events or to do items for a user of the handheld communication device.

60. The method of claim 55 further comprising selecting with a pointing device or using voice commands, an user application associated with at least a portion of the application information through interaction with the browser.

61. The method of claim 60 wherein the pointing device comprises one or more of: a stylus, a fingertip stylus, a finger, or one or more buttons.

62. The method of claim 55 wherein the system status information is conveyed through status icons comprising one or more of: a logo icon, a program group icon, an application name icon, a battery life indicator icon, a current time indicator icon, a received signal strength indicator icon, a help icon, a voice mail indicator icon, an input toggle icon, a backpack software icon, or a Bluetooth icon.

63. The method of claim 55 wherein the application information comprises information regarding one or more user applications chosen from the list including: communication applications, personal information management applications, personal productivity applications, multimedia applications, or game applications.

64. The method of claim 63 wherein the communication applications comprise one or more of: a telephone dialer, an e-mail application, a short messaging service application, an Internet browser, a wireless access protocol browser, an instant messenger application, or a Bluetooth communication application.

65. The method of claim 63 wherein the personal productivity applications comprise one or more of: a text editor, a spreadsheet, a database, an e-book reader, an image viewer, an image editor, or an audio manager.

66. The method of claim 55 wherein the browser further executes to display advertisement information in a designated area of the application window.

67. The method of claim 55 wherein different categories of user interactions with the browser initiate different user application responses.

68. The method of claim 67 wherein the different categories of user interactions are selected from the list comprising: a single selection operation, a select and hold operation and a double selection operation.

69. The method of claim 55 wherein the current or recent application information is displayed in the browser in so as to be navigable in a circular fashion.

70. The method of claim 55 wherein the system window is located at the top of a display area of the handheld communication device.

71. The method of claim 70 wherein the application window is located below the system window.

72. The method of claim 71 wherein the browser displays an HTML page that includes an area reserved for displaying advertising information that is configured to display one or more of: streaming media information, flash animation information, banner ads, packet video information, gif animations, image files, or multimedia information.

73. The method of claim 72 wherein the area reserved for displaying advertising information is located at the bottom of the application window.

74. The method of claim 55 wherein the system window includes an area reserved for display of a logo icon.

75. The method of claim 74 wherein selection of the logo icon causes a folder menu to be displayed on a display of the handheld communication device.

76. The method of claim 75 wherein the folder menu includes an area reserved for a listing of recently used ones of the user applications.

77. The method of claim 76 wherein the recently used ones of the user applications are displayed as icons within the reserved area.

78. The method of claim 75 wherein the folder menu comprises a dropdown menu of available application groups for the handheld communication device.

79. The method of claim 78 wherein the application groups include one or more of: an all application group, a communication application group, a multimedia application group, a personal productivity application group, a main application group that includes a personal information manager application, a games application group, a system application group, and a user personal applications group.

80. The method of claim 79 wherein selection of one of the application groups causes a window that includes images representing those of the user applications that belong to the selected application group to be opened.

81. A user interface for a handheld communication device, comprising a number of screen areas, one of which is devoted to a system window in which a system application for controlling the operation of the handheld communication device executes, and another of which is devoted to an application window in which a browser executes to display an HTML-based interface page comprising current or recent application information for respective user applications of the handheld communication device.

82. The user interface of claim 81 wherein the system application executes to display status icons for the system operations of the handheld communication device.

83. The user interface of claim 82 wherein the system application further executes to permit user access to a main menu.

84. The user interface of claim 82 wherein the HTML-based interface page is configured to allow for one or more of the user applications to be accessed through user interaction with the interface page.

85. The user interface of claim 84 wherein the user interaction comprises one or more of:
selection with a stylus, selection with one or more buttons or selection through voice commands.

86. The user interface of claim 84 wherein the HTML interface page is linked with other interface pages.

87. The user interface of claim 84 wherein the HTML interface page is downloaded to the handheld communication device from a remote location.

88. The user interface of claim 87 wherein the remote location comprises a server.

89. The user interface of claim 83 wherein the main menu includes a number of application group indicators which link to dynamically generated interface pages, each of which are configured to list applications associated with a respective application group.

90. The user interface of claim 89 wherein the dynamically generated interface pages list applications associated with a respective application group using images representing those applications.

91. The user interface of claim 90 wherein through user interaction with the images, associated applications are launched by a controller.

92. The user interface of claim 91 wherein the application groups comprise one or more of: an all application group, a communication application group, a multimedia application group, a personal productivity application group, a main application group that includes a personal information manager application, a games application group, a system application group, and a user personal applications group.

93. The user interface of claim 92 wherein the communication application group comprises one or more of: a telephone dialer, an e-mail application, a short messaging service application, an Internet browser, a wireless access protocol browser, an instant messenger application, or a Bluetooth communication application.

94. The user interface of claim 92 wherein the personal productivity applications comprise one or more of: a text editor, a spreadsheet, a database, an e-book reader, an image viewer, an image editor, or an audio manager.
